(19) United States
(12) Patent Application Publication
(10) Pub. No.: US 2024/0011638 A1
(43) Pub. Date: Jan. 11, 2024

(54) PELLET GRILL

(71) Applicant: Hangzhou Yixiang Technology R&D Co., LTD, Hangzhou (CN)

(72) Inventors: Baichen Dong, Newark, CA (US); Yulin Ye, Hangzhou, Zhejiang (CN); Jianing Zhu, Shanghai (CN); Bingchen Jin, Hangzhou, Zhejiang (CN); Zhiling Lian, Shenzhen, Guangdong (CN)

(21) Appl. No.: 17/881,637

(22) Filed: Aug. 5, 2022

(30) Foreign Application Priority Data
Jul. 8, 2022 (CN) 202221780894.7

(51) Int. Cl. F24B 1/00; F24B 13/00; F24C 15/14; A47J 37/07

(52) U.S. Cl. CPC F24B 1/003; F24B 13/008; F24C 15/14; A47J 37/0786

(57) ABSTRACT

Disclosed is a pellet grill. The grill includes a housing with an opening, a pellet bin and a burning bin, the pellet bin being in communication with the burning bin; and the grill further includes an ash clearing pan, the ash clearing pan is positioned in the burning bin, the ash clearing pan is detachably connected to an inner wall of the burning bin, the ash clearing pan is provided with handles, and the handles are fixedly connected to the ash clearing pan. By using the above design, the ash clearing pan is arranged in the grill such that grill ash may be conveniently collected. Moreover, the handles are arranged such that when the grill ash is required to be cleared, the ash clearing pan may be taken out only by means of the handles, thereby improving cleaning convenience and economic benefits of the grill.

### CROSS REFERENCE TO RELATED APPLICATIONS

The present application claims the benefit of Chinese Patent Application No. 202221780894.7 filed on Jul. 8, 2022, the contents of which are incorporated herein by reference in their entirety.

### Technical Field

The present disclosure relates to the technical field of grills, in particular to a pellet grill.

### Background Art

As an outdoor leisure dinner activity, barbecue is really popular with the public because it is suitable for people of all ages, and people can gain a sense of achievement by having a barbecue by themselves. A barbecue device can use charcoal and wood pellets as fuel, and can also use electricity for heating. After being burnt, wood pellets and charcoal will become gray grill ash to be accumulated at the bottom of a grill. After a barbecue grill in the prior art is used for a long time, burning ash in the grill is required to be cleared during or at the end of barbecue. However, it is troublesome to clear ash because a grill, etc. are required to be disassembled, and moreover, a user needs a dust collector or other tools to clear dust that is accumulated on a bottom wall.

Accordingly, it is urgent to design a pellet grill, so as to overcome the defects in the prior art.

### SUMMARY

In order to achieve the above objective, the present disclosure employs the technical solution: a pellet grill includes a housing with an opening, a pellet bin and a burning bin, the pellet bin being in communication with the burning bin. The grill further includes an ash clearing pan, the ash clearing pan is positioned in the burning bin, the ash clearing pan is detachably connected to an inner wall of the burning bin, the ash clearing pan is provided with handles, and the handles are fixedly connected to the ash clearing pan.

In a preferential embodiment, a bottom wall of the burning bin supports the ash clearing pan, the handles are positioned at two ends of the ash clearing pan, and the handles are kept away from a side wall of the burning bin or a height of each handle in a vertical direction is higher than that of the side wall of the burning bin.

In a preferential embodiment, the handles are provided with handrails, and two ends of each handrail have a level difference.

In a preferential embodiment, the grill further includes an oil dripping pan. The oil dripping pan is positioned at an upper portion of the ash clearing pan, and ends of the oil dripping pan abut against the handrails.

In a preferential embodiment, the grill further includes an oil dripping pipe and an oil bin. The oil dripping pipe is positioned in the burning bin, the oil dripping pipe is fixed to the inner wall of the burning bin, the oil bin is detachably connected to the burning bin, and the oil dripping pipe is in communication with the oil bin.

In a preferential embodiment, a periphery of the oil dripping pan is provided with a surrounding edge, the surrounding edge is provided with an oil dripping port, and the oil dripping port corresponds to the oil dripping pipe, such that oil in the oil dripping pan flows into the oil dripping pipe by means of the oil dripping port.

In a preferential embodiment, two ends of the oil dripping pan are provided with limiting grooves respectively, and the handles are positioned in the limiting grooves.

In a preferential embodiment, the grill further includes an open flame baffle. The open flame baffle is positioned above the oil dripping pan, two ends of the open flame baffle are provided with raised oil blocking ribs respectively, two sides of the open flame baffle are provided with vertical flanges respectively, the oil blocking ribs are perpendicular to the flanges, and ends of the oil blocking ribs and the flanges are arranged at intervals.

In a preferential embodiment, the ash clearing pan is provided with a flame outlet, the bottom wall of the burning bin is provided with a burning chamber corresponding to the flame outlet, pellets in the pellet bin are conveyed to the burning chamber, and the pellets in the pellet bin are burnt in the burning chamber.

In a preferential embodiment, the oil dripping pan is provided with flame outlet grooves, the flame outlet grooves are positioned in a middle of the oil dripping pan, the flame outlet is positioned in the middle of the ash clearing pan, and the flame outlet is opposite the flame outlet grooves.

Beneficial effects of the present disclosure: according to the present disclosure, the ash clearing pan is arranged in the grill such that grill ash may be conveniently collected. Moreover, the oil dripping pan and the open flame baffle are arranged on the handles of the ash clearing pan, such that when the grill ash is required to be cleared, the ash clearing pan, a bottom oil pan and the open flame baffle may be taken out together by means of the handles, thereby improving cleaning convenience and economic benefits of the grill.

### BRIEF DESCRIPTION OF THE DRAWINGS

FIG. 1 is a structural schematic diagram of the present disclosure;

FIG. 2 is an exploded view of the present disclosure;

FIG. 3 is a schematic structural diagram of an open flame baffle in the present disclosure;

FIG. 4 is a structural view of an oil dripping plate in the present disclosure;

FIG. 5 is a schematic structural diagram of an ash clearing pan in the present disclosure; and

FIG. 6 is a sectional view of a pellet bin in the present disclosure.

In the accompanying drawings:

10. housing, 11. pellet bin, 12. material guiding plate, 13. sieve plate, 14. top cover,

20. ash clearing pan, 21. handle, 22. handrail, 23. flame outlet,

30. oil dripping pan, 31. limiting groove, 32. surrounding edge, 33. oil dripping port, 34. flame outlet groove,

40. open flame baffle, 41. oil blocking rib, 42, flange,

50. oil dripping pipe, and 51. oil bin.

### DETAILED DESCRIPTION OF THE EMBODIMENTS

In order to enable the above objectives, features, and advantages of the present disclosure to be more apparent and easily understood, specific embodiments of the present disclosure will be described in detail below with reference to the accompanying drawings. Many specific details are set forth in the following description to facilitate full understanding of the present disclosure. However, the present disclosure may be implemented in many other ways different from those described herein, similar improvements may be made by those skilled in the art without departing from the connotation of the present disclosure, and therefore the present disclosure is not limited by the specific embodiments disclosed below.

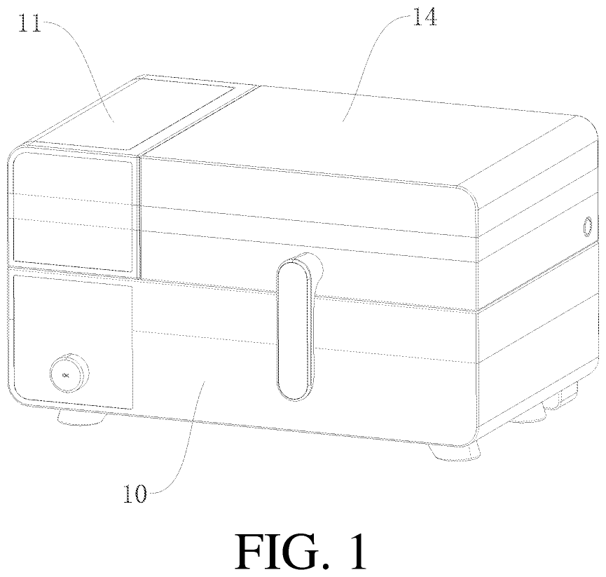

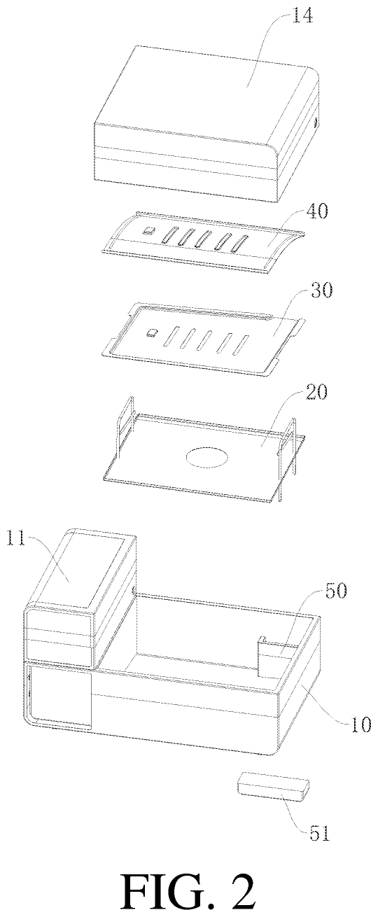

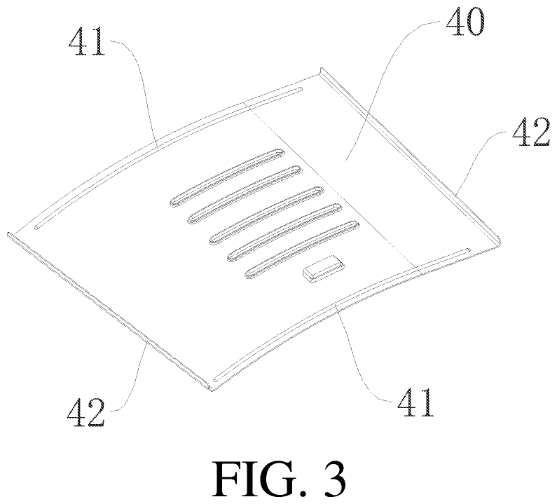

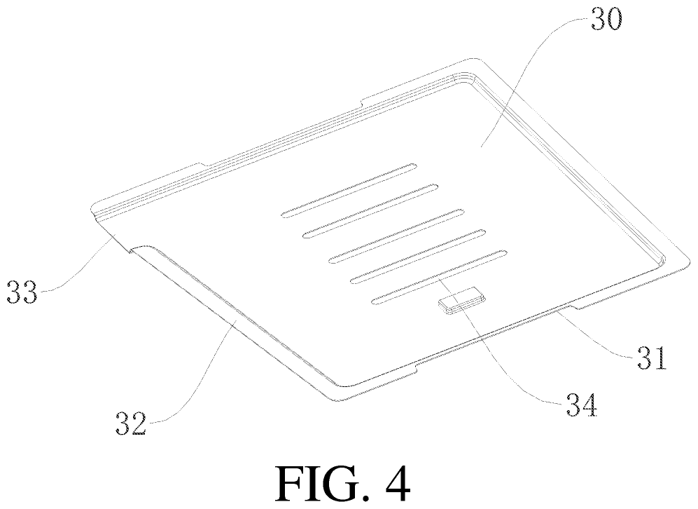

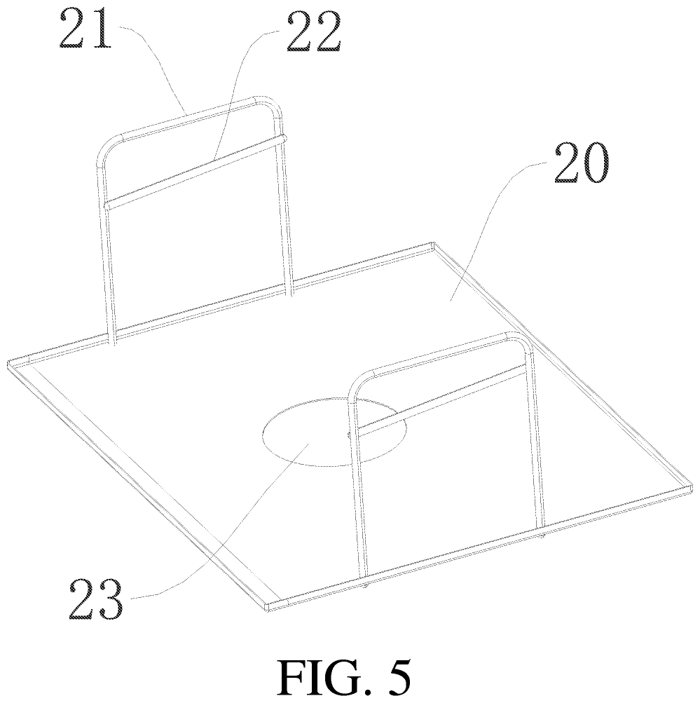

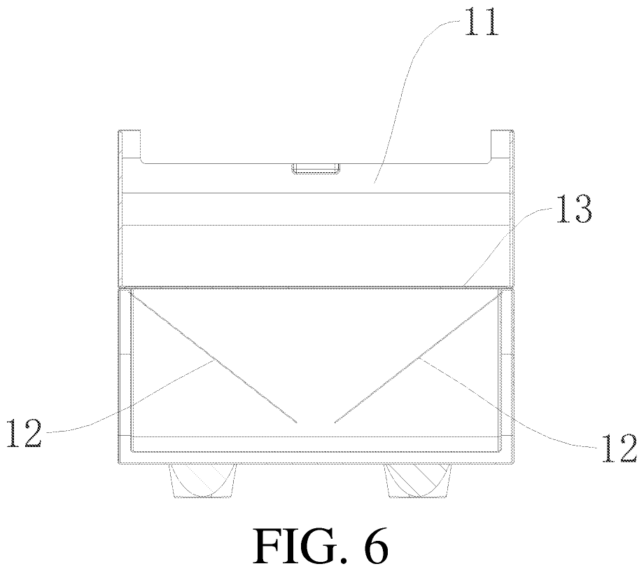

As shown in FIGS. 1-6, the present disclosure provides a pellet grill. The grill includes a housing 10 with a top opening, one end of the housing 10 is provided with a pellet bin 11, and the other end thereof is provided with a burning bin (not shown in the figures). An ash clearing pan 20, an oil dripping pan 30 and an open flame baffle 40 are further arranged in the pellet grill, a bottom wall of the burning bin supports the ash clearing pan 20, the ash clearing pan 20 is arranged above the bottom wall of the burning bin, and the ash clearing pan 20 is partially or completely arranged in the burning bin. The oil dripping pan 30 is positioned at an upper portion of the ash clearing pan 20, the ash clearing pan 20 supports the oil dripping pan 30, and the oil dripping pan 30 is partially or completely positioned in the burning bin. The open flame baffle is positioned above the oil dripping pan 30, the oil dripping pan 30 supports the open flame baffle 40, and the open flame baffle 40 may slide relative to the oil dripping pan 30. The ash clearing pan 20, the oil dripping pan 30 and the open flame baffle 40 are all detachably connected to a wall of the burning bin, the oil dripping pan 30 is detachably connected to the ash clearing pan 20, and the open flame baffle 40 is detachably connected to the oil dripping pan 30 such that each component may be cleaned, replaced and maintained.

Two ends of the ash clearing pan 20 are fixedly provided with handles 21 respectively, and tops of the handles 21 are provided with handrails 22 inclined. Two ends of the oil dripping pan 30 abut against the corresponding handrails 22 respectively, the oil dripping pan 30 is suspended above the ash clearing pan 20 by means of the handrails 22, and the oil dripping pan and the open flame baffle 40 are provided with flame outlet grooves 34 corresponding to each other respectively. A middle of the ash clearing pan 20 is provided with a flame outlet 23, and a bottom of the burning bin is provided with a burning chamber (not shown in the figures) corresponding to the flame outlet 23. Specifically, the pellet bin 11 is used for carrying pellet combustibles, the pellet bin 11 is in communication with the burning chamber of the burning bin, and pellets in the pellet bin are burnt in the burning chamber. The ash clearing pan 20 and the oil dripping pan 30 arranged at intervals with the ash clearing pan 20 are arranged above the burning chamber, and the ash clearing pan 20 is attached to a bottom wall of the burning bin such that dust generated when the pellet combustibles are burnt is prevented from entering a gap between the ash clearing pan 20 and the burning bin.

The ash clearing pan 20 may be conveniently taken out from the housing 10 by means of the handles 21, the oil dripping pan 30 is above the ash clearing pan 20, and the oil dripping pan 30 has a function of blocking dust of combustibles between the oil dripping pan 30 and the ash clearing pan 20 such that more dust of the combustibles may fall into the ash clearing pan 20. The open flame baffle 40 is arranged above the oil dripping pan 30, and both the oil dripping pan and the open flame baffle 40 may be used for carrying food to be grilled.

The oil dripping pan 30 is fixed above the ash clearing pan 20 by means of the handrails 22 on the handle 21s, and the oil dripping pan 30 is inclined by means of the handrails 22, such that the oil dripping pan 30 is also in an inclined state. A middle of the open flame baffle 40 and a middle of the oil dripping pan 30 are both provided with a plurality of flame outlet grooves 34 at intervals, moreover, a middle of the ash clearing pan 20 is provided with a flame outlet 23, and flames generated when pellet combustibles are burnt rush out by means of the flame outlet 23 and the flame outlet grooves 34. Food to be grilled is placed on the open flame baffle 40 to be grilled by means of open flames, part of oil generated when the food to be grilled is grilled will drip on the oil dripping pan 30, and at this time, the oil dripping on the oil dripping pan 30 collectively flow to one side at a lower position of the oil dripping pan 30 due to an inclined state of the oil dripping pan 30 such that the oil may be conveniently collectively treated. Moreover, after barbecue is finished, the oil dripping pan 30 and the open flame baffle 40 positioned above the ash clearing pan 20 may be taken out of the housing 10 together with the ash clearing pan 20 by means of the handles 21, so as to conveniently clear dust in the burning bin.

It can be understood that the handrails 22 may be further horizontally arranged, two handles 21 are arranged at two ends of the oil dripping pan 30 respectively, two handrails 22 are arranged corresponding to the handles 21, and the two handrails 22 have different horizontal heights, such that the oil dripping pan 30 has an inclined angle. Therefore, the oil on the oil dripping pan 30 may conveniently flow to a lower side of the oil dripping pan 30, so as to be conveniently treated. Similarly, the oil dripping pan 30 may be inclined towards the left and right or towards the front and back by means of the handrails 22 such that the oil is collected at one corner of the oil dripping pan 30.

When a height of each handle 21 is equal to that of a side wall of the burning bin, or a height of each handle 21 is lower than that of a side wall of the burning bin, the handles 21 keep away from the side wall of the burning bin, such that hands of a user may conveniently pass through a space between the handles 21 and the side wall of the burning bin, and the user may conveniently grasp the handles 21. Alternatively, a height of each handle 21 is higher than a side wall of the burning bin, such that a user may conveniently grasp the handles 21, and user convenience is improved.

Further, in the embodiment, the burning bin is internally provided with a conveying mechanism (not shown in the figures), the conveying mechanism is in communication with the pellet bin 11 and the burning chamber, and the burning chamber is positioned in a middle of the burning bin. Specifically, the conveying mechanism is used for conveying pellet combustibles positioned in the pellet bin 11 to the burning chamber to be burnt. The burning chamber is arranged to make burnt pellets collected at one place such that flames may be conveniently collected, and roasting efficiency is improved. The burning chamber corresponds to the flame outlet 23, such that the flames act on the oil dripping plate 30 by means of the burning chamber and the flame outlet 23. For food not easy to be grilled by means of open flames, the oil dripping plate 30 may be heated by the flames, and heat generated by the oil dripping plate 30 is transferred to the food. Moreover, the food is kept away from the flame outlet grooves 34 of the oil dripping plate 30, such that possibility of scorching the food is reduced. For food suitable for being grilled by means of open flames, the food may be placed at the flame outlet grooves 34 to be grilled by the flames rushing out from the flame outlet grooves 34.

Further, in the embodiment, one side wall of the burning bin is provided with an oil dripping pipe 50, the oil dripping pipe 50 is positioned in the burning bin, and the oil dripping pipe 50 is fixed to the side wall of the burning bin. An oil bin 51 is detachably arranged outside a bottom of the housing 10, the oil dripping pipe 50 is in communication with the oil bin 51, the oil bin 51 is positioned below the oil dripping pipe 50, and oil may flow from the oil dripping pipe 50 to the oil bin 51 under the action of gravity, such that a user may conveniently collect and clear oil stains. Specifically, the oil bin 51 is used for collecting oil generated when food is grilled, the oil in the oil dripping pan 30 and the open flame baffle 40 may be conveniently conveyed into the oil bin 51 by means of the oil dripping pipe 50, and the oil bin 51 is detachably connected, such that the oil bin may be disassembled to clear oil and clean the oil bin 51 when the oil bin 51 is full.

Further, two ends of the oil dripping pan 30 are provided with limiting grooves 31 respectively, and the handles 21 are positioned in the limiting grooves 31. A height of one end of the oil dripping pan 30 is less than that of the other end, a side of the oil dripping pan 30 is provided with a surrounding edge 32, an end having a lower height of the oil dripping pan 30 is provided with an oil dripping port 33, the surrounding edge 32 and the oil dripping port 33 are arranged to enable oil in the oil dripping pan 30 to be discharged by means of the oil dripping port 33, and the oil dripping port 33 corresponds to the oil dripping pipe 50. Specifically, through matching between the limiting grooves 31 and the handles 21, the oil dripping pan 30 is limited and may not horizontally move, so as to prevent the oil dripping pan 30 from sliding in an inclined state. In order to improve fluidity of oil on the oil dripping pan 30, a height of one end of the oil dripping pan 30 is less than that of the other end. When the oil drips on the oil dripping pan 30, the oil flows to a lower position due to an inclined arrangement of the oil dripping pan 30, and is collected on one side of the lower position due to limitation of the surrounding edge 32. Moreover, since a height of one end is less than that of the other end, a high difference is formed. When oil is collected at one side, the oil automatically flows to the lower end, and the lower end of the bottom oil pan is provided with an oil dripping port 33, and the oil dripping port 33 corresponds to the oil dripping pipe 50, such that oil directly flows into the oil dripping pipe 50 by means of the oil dripping port 33, and flows into the oil bin 51 along with the oil dripping pipe 50.

Further, in the embodiment, a section of the open flame baffle 40 is in an arc, two ends of the open flame baffle 40 are provided with raised oil blocking ribs 41 respectively, two sides of the open flame baffle 40 are provided with vertical flanges 42 respectively, and ends of the oil blocking ribs 41 and the flanges 42 are arranged at intervals. Specifically, the section of the open flame baffle 40 is in an arc, such that oil flows to a lower position when food is placed on the open flame baffle to be grilled. Two ends of the open flame baffle 40 are provided with raised oil blocking ribs 41 respectively, and two sides of the open flame baffle 40 are provided with flanges 42 respectively, which are both used for blocking oil flowing to two ends, and preventing oil from dripping from gaps between the two ends of the open flame baffle 40 and the inner wall of the housing 10.

Further, the open flame baffle 40 is positioned on the oil dripping pan 30, and a height of one end of the oil dripping pan 30 is less than that of the other end, such that a height of one end of the open flame baffle 40 is less than that of the other end. Specifically, since the open flame baffle 40 is inclined, oil flows from a higher end to a lower end. Moreover, ends of the oil blocking ribs 41 and ends of the flanges 42 are arranged at intervals, such that oil flows out from gaps to the oil dripping pan 30, and then flows into the oil dripping pipe 50 from the oil dripping pan 30.

Further, the grill further includes a top cover 14, and one side of the top cover 14 is hinged to one side of a top of the housing 10. Specifically, one side of the top cover 14 is hinged to one side of the housing 10, and when not in use, the top cover 14 may be grilled to cover the housing 10.

Further, in the embodiment, two ends of the pellet bin 11 are internally provided with material guiding plates 12 respectively, and tail ends of the two material guiding plates 12 are inclined towards directions of approaching each other. Specifically, when the pellet combustibles are put into the pellet bin 11, the pellet combustibles collectively flow to one position by means of the material guiding plates 12, collection positions of the material guiding plate 12 correspond to a conveying mechanism, such that the pellet combustibles are directly guided into the conveying mechanism, and then the pellet combustibles are conveyed into the burning chamber by means of the conveying mechanism to be burnt.

Further, in the embodiment, the pellet bin 11 is internally provided with a sieve plate 13 above the material guiding plates 12. Specifically, the sieve plate 13 is used for filtering large pellet combustibles, so as to prevent the conveying mechanism from being blocked and prevent a user from putting fingers into the conveying mechanism.

In summary, according to the present disclosure, the ash clearing pan is arranged in the grill such that grill ash may be conveniently collected. Moreover, the oil dripping pan and the open flame baffle are arranged on the handles of the ash clearing pan, such that when the grill ash is required to be cleared, the ash clearing pan, a bottom oil pan and the open flame baffle may be taken out together by means of the handles, thereby improving cleaning convenience and economic benefits of the grill.

The present disclosure is not only limited to the descriptions in the specification and implementations, such that those skilled in the art may easily achieve additional advantages and modifications. Therefore, the present disclosure is not limited to specific details, representative apparatus and illustrative examples shown and described herein without departing from the spirit and scope of the general concept as defined by the append claims and equivalents thereof.

What is claimed is:

1. A pellet grill, comprising a housing with an opening, a pellet bin and a burning bin, the pellet bin being in communication with the burning bin, wherein the grill further comprises an ash clearing pan, the ash clearing pan is positioned in the burning bin, the ash clearing pan is detachably connected to an inner wall of the burning bin, the ash clearing pan is provided with handles, and the handles are fixedly connected to the ash clearing pan.

2. The pellet grill according to claim 1, wherein a bottom wall of the burning bin supports the ash clearing pan, the handles are positioned at two ends of the ash clearing pan, and the handles are kept away from a side wall of the burning bin or a height of each handle in a vertical direction is higher than that of the side wall of the burning bin.

3. The pellet grill according to claim 2, wherein the handles are provided with handrails, and two ends of each handrail have a level difference.

4. The pellet grill according to claim 3, further comprising an oil dripping pan, wherein the oil dripping pan is positioned at an upper portion of the ash clearing pan, and ends of the oil dripping pan abut against the handrails.

5. The pellet grill according to claim 4, further comprising an oil dripping pipe and an oil bin, wherein the oil dripping pipe is positioned in the burning bin, the oil dripping pipe is fixed to the inner wall of the burning bin, the oil bin is detachably connected to the burning bin, and the oil dripping pipe is in communication with the oil bin.

6. The pellet grill according to claim 5, wherein a periphery of the oil dripping pan is provided with a surrounding edge, the surrounding edge is provided with an oil dripping port, and the oil dripping port corresponds to the oil dripping pipe, such that oil in the oil dripping pan flows into the oil dripping pipe by means of the oil dripping port.

7. The pellet grill according to claim 4, wherein two ends of the oil dripping pan are provided with limiting grooves respectively, and the handles are positioned in the limiting grooves.

8. The pellet grill according to claim 4, further comprising an open flame baffle, wherein the open flame baffle is positioned above the oil dripping pan, two ends of the open flame baffle are provided with raised oil blocking ribs respectively, two sides of the open flame baffle are provided with vertical flanges respectively, the oil blocking ribs are perpendicular to the flanges, and ends of the oil blocking ribs and the flanges are arranged at intervals.

9. The pellet grill according to claim 4, wherein the ash clearing pan is provided with a flame outlet, the bottom wall of the burning bin is provided with a burning chamber corresponding to the flame outlet, pellets in the pellet bin are conveyed to the burning chamber, and the pellets in the pellet bin are burnt in the burning chamber.

10. The pellet grill according to claim 9, wherein the oil dripping pan is provided with flame outlet grooves, the flame outlet grooves are positioned in a middle of the oil dripping pan, the flame outlet is positioned in the middle of the ash clearing pan, and the flame outlet is opposite the flame outlet grooves.
